(19) United States
(12) Patent Application Publication
(10) Pub. No.: US 2003/0020595 A1
(43) Pub. Date: Jan. 30, 2003

(54) System and method for configuration of wireless networks using position information

(75) Inventor: Ihor Wacyk, Briarcliff Manor, NY (US)

Correspondence Address: Corporate Patent Counsel, U.S. Philips Corporation, 580 White Plains Road, Tarrytown, NY, 10591, US

(73) Assignee: Philips Electronics North America Corp.

(21) Appl. No.: 09/903,882

(22) Filed: Jul. 12, 2001

(51) Int. Cl. G05B 23/02

(52) U.S. Cl. 340/3.5; 340/3.52

(57) ABSTRACT

A method of binding one or more lamps from a neighborhood group into a control group that are controlled together. First, the addresses of the lamps in the neighborhood group are requested. The first address received from the lamps in response to the address request is considered as an address (represented as ADDR1) of a first lamp in the neighborhood group. The lamps in the neighborhood group are queried as to whether they have address ADDR1 of the first lamp in the neighborhood. A response to the query is received, of course, from the first lamp, which has address ADDR1. In addition, it is determined whether one or more additional responses to the query are received from one or more of the other lamps in the neighborhood group. If additional responses are received, all lamps having address ADDR1 are instructed to randomize their addresses. These steps are repeated starting with the request for the addresses of the lamps in the neighborhood group until it is determined that no additional responses are received to the query regarding which lamps have address ADDR1.

### BACKGROUND OF THE INVENTION

1. Field of the Invention

The present invention generally relates to wireless control of lighting fixtures and lamps, and more specifically to a system and method for configuring networks for controlling lighting fixtures and lamps using positional information of the lighting fixtures and lamps.

2. Description of the Related Art

Currently available lighting control systems use infrared (IR) signals and/or radio frequency (RF) signals to control lighting fixtures or lamps. Referring to FIG. 1, a section of a known lighting system that incorporates IR control is shown. Two lamps 10a, 10b are located in a region R. Controller 12 is connected to each lamp 10a, 10b and is used to turn the lamps on and off. Infrared sensor 14 receives IR signals from IR transmitter 16 which may be, for example, a hand-held transmitter 16. When the IR transmitter 16 is pointed at sensor 14 and caused to emit an IR signal 18, IR sensor 14 signals controller 12 to change the state of lamps 10a, 10b, that is, turn them either on or off.

In addition, controller 12 is controlled by a computer (not shown) via a network that includes bus 20 connected to network control box 22 that connects to controller 12. Thus, lamps 10a, 10b may also be controlled via the network. The network may include many other regions, one of which is shown in FIG. 1 denoted with prime reference numbers. As shown, the lamps in the other regions may also be controlled by an IR transmitter (such as transmitter 16′) or via the network control. IR control has a number of disadvantages. For example, IR transmitters and receivers are relatively expensive. In addition, IR transmitters have a relatively narrow beam and thus require a clear, unimpeded line of sight between the transmitter and receiver. Thus, for example, if an IR transmitter located in a ceiling is to control a number of lamps in a large open office area, a large number of high powered LEDs are required with a complex geometrical relationship between the transmitter and the receivers adjacent the lamp controllers. Also, in general, an IR receiver and controller must be wired to each single lamp to be controlled, once again adding to the cost and complexity.

RF control eliminates or reduces many of the disadvantages of IR control. Referring to FIG. 2, an analogous section of a known lighting system that incorporates RF control is shown. Again, two lamps 50a, 50b are located in a region R. An RF transceiver is wired into each lamp 50a, 50b; thus, each lamp 50a, 50b has a separate RF antenna 52a, 52b, respectively. Wireless controller 56 transmits RF signals 58 to turn lamps 50a, 50b either on or off. The RF signal is emitted in all directions and does not require a line of sight to be detected. Thus, if the RF signal 58 from controller 56 includes the electronic addresses for the receivers of both lamps 50a, 50b, it will control both lamps with a single enactment of controller 56.

In addition, network control box 62 is connected to a computer network via bus 60. Network control box 62 also has an RF antenna 64 that transmits RF signals 68 which may include addressing to switch lamps 50a, 50b on and off. Adjacent region R′ of the system is again represented with analogous components denoted with prime reference numbers. In addition, with the proper addressing, the RF signal 68 emitted by the single network control box 62 can control the lamps in both regions.

Thus, the RF control can achieve broad coverage with fewer RF transmitters and, because the RF penetrates walls and is emitted in an omnidirectional manner, provides a less complex and costly implementation. Little or no wiring (or re-wiring) is required. Referring to FIG. 2, implementation of the RF control requires, at most, that the network control box be re-fitted with an RF transmitter and that lamps 50a, 50b be replaced with lamps having RF transceivers and a modest processor, microprocessor or other processing device. Importantly, when RF control is used, each lamp has its own transceiver; thus, there is no wiring between the lamps and controllers (such as controller 12 shown in FIG. 1). This provides total flexibility in changing groupings of lamps that are controlled by a controller, such as controller 56 or a controller housed in a network computer and/or network control box 62 (hereinafter referred to as a simply a “network control box” in the controller context) shown in FIG. 2.

Thus, RF control eliminates the need to re-wire each group of lamps to a serving controller when a change in the configuration of the lamps is needed (for example, when a modular office is re-cast in a new configuration). Instead, for the RF process, there is a “binding” of lamps to the control of a particular controller, which may be, for example, a hand-held remote style controller (with transceiver) or a network control box. Binding is the process of organizing lamps into groups based on their location, function, or other commonality. Thus, the RF transceiver and processor integrated into each lamp comes with a built-in address. The lamps, including the RF transceivers and processors are installed in fixtures, ceilings, etc., initially without any defined associations with any controller. (Although the generic term “lamp” is used, in the RF context below the term “lamp” is understood to include the RF transceiver and related processing capability.) The binding process associates or programs the address of one or more lamp with a particular controller. (A network control box as described above generally performs the same RF control as a remote or hand-held controller, so the description will focus on the latter, generically referred to as the “controller”.) The binding process allows quick re-configuration of the lamps by associating the address of a lamp with a different controller which, as noted, is typically much simpler and less expensive than re-wiring.

After installation, the lamp receivers are generally not readily accessible. Thus, the bindings necessary to establish a link between a controller and a lamp are generally performed without any physical contact with the lamps.

RF control does suffer from a number of disadvantages of its own, however. One such problem associated with RF control of a wireless lighting network is the binding of lamps described above to a particular controller and/or network control box. In the common wireless network employing RF control, each lamp receiver is pre-programmed with an address and will only respond to control signals from a controller emitting an RF signal that includes the address. Unfortunately, the number of addresses is a finite number and often more than one lamp will have the same address. Where lamps having a common address are controlled by different controllers, interference may arise. That is, the RF signal from a controller may reach a lamp that is not part of its group of controlled lamps. If that lamp has the same address as one of the lamps in the group, then the lamp will respond to the RF signals.

Interference is especially likely in a network where many lamps are within broadcast range of a controller, for example, where the lamps are located in adjacent rooms and floors. Individual lamps typically come with pre-programmed addresses. Addresses that are sufficiently long (typically 30 bits or more) ensure that the there is a very small probability that nearby lamp receivers will have the same address (referred to as “overlap”) . However, not all manufacturers provide their lamps with long addresses. In addition, even though typical wired digital networks have receivers that come with a random long address, they are ultimately re-assign a short address for normal operation. (An example of this is a Digital Addressable Lighting Interface (DALI) standard network) A short address increases the likelihood of overlap. While the overlap of short addresses may theoretically be reduced or eliminated by pre-programming all lamp receivers with unique addresses, the required cooperation between different manufacturers (or a governing standard) is unlikely to be implemented.

An actual binding procedure, wherein lamps are associated with a controller transmitter, highlights the overlap problem. Where it is desired to associate a number of neighboring lamps as part of the control group of a particular controller, an important step in the binding procedure is that the controller “discover” the address of each lamp to be included in the group. Various algorithms or protocols exist to perform this task. Generally, the binding procedure includes the steps of 1) identifying the presence of unattached lamps that are not bound (“attached”) to any controller, 2) determining the address of one such unattached lamp and selecting it, 3) providing a visual indication of the selected lamp in order to determine whether it is a lamp that is desired to be in the group, and 4) if so, binding the lamp. The binding can occur by programming the lamp's address into the controller. Alternatively, the controller may adopt a new address that is unique from any others programmed in the controller and re-program the lamp with a new address. The controller then proceeds to the next unattached lamp.

By requesting that the lamp provide a visual signal (like flashing the lamp), it is possible for the programmer to see which of the unattached lamps has been selected and to verify that it is within the desired group to be bound. If so, then as noted the actual programming is implemented for the lamp. However, if a second lamp has the same address as a selected lamp, then the second lamp will also be bound as part of the group when the above-described binding protocol is followed. Even where the controller adopts a unique new address and transmits the new address to the lamp for re-programming by the lamp's processor, the address of the second lamp will likewise be reprogrammed and consequently will be bound. Thus, the second lamp is again included in the group with the re-programmed address. This unintended binding of the second lamp is, of course, due to the overlap with the address of the lamp that is intended to be bound.

Such an unintended binding of the second lamp cannot be prevented, even if the visual signal given by the second lamp after selection is visible to the programmer. However, where the second lamp is located in another region (for example, in an adjacent room or floor), the unintended binding may occur without the programmer even detecting the binding, because the programmer will not see the visual signal of the second lamp.

Thus there is a need for a system and method for binding a wireless control system, the system and method having a low cost, small interference probabilities, and an ease of reconfiguration.

### SUMMARY OF THE INVENTION

It is, therefore, an object of the present invention to provide a system and method for binding a group of devices, such as lamps, where there is no unintended binding of a particular lamp or lamps.

Accordingly, the invention comprises a method of binding one or more devices, for example, lamps, from a neighborhood group into a control group that are controlled together. First, the addresses of the devices in the neighborhood group are requested. The first address received from the devices in response to the address request is considered as an address (represented as ADDR1) of a first device in the neighborhood group. The devices in the neighborhood group are queried as to whether they have address ADDR1 of the first device in the neighborhood. A response to the query is received, of course, from the first device, which has address ADDR1. In addition, it is determined whether one or more additional responses to the query are received from one or more of the other devices in the neighborhood group. If additional responses are received, all devices having address ADDR1 are instructed to randomize their addresses. These steps are repeated starting with the request for the addresses of the devices in the neighborhood group until it is determined that no additional responses are received to the query regarding which devices have address ADDR1.

After it is determined that no additional responses are received to the query, the method further comprises instructing the first device to provide a sensory output that identifies the first device to an operator. This may be a visual output by the device. For example, where the device is a lamp, the lamp may dim its light output. In another example, where the device is a wireless speaker, the speaker may provide an audio output. The first device is either bound as part of the control group or left unbound. In either case, the first device is removed from further consideration in the binding procedure and the steps are repeated beginning with the request for the addresses of the devices in the neighborhood group.

In addition, the invention comprises a system comprising a wireless controller that binds one or more devices from a neighborhood group of devices to the controller. The controller has a processor that processes data and formats signals and a transceiver that transmits and receives signals. In a binding procedure, the controller sends a transmit address request signal to the devices in the neighborhood group. The controller uses a first address received from the devices in response to the address request signal as the address (represented as ADDR1) of the first device in the neighborhood.

The controller then transmits an address inquiry signal to address ADDR1. The controller receives back a response to the address inquiry signal from the first device, since it has address ADDR1. The controller also determines whether one or more additional responses to the address inquiry signal directed at address ADDR1 are received from one or more of the other devices in the neighborhood group. If one or more additional responses are received, the controller sends a randomize address signal addressed to ADDR1.

Where the controller sends a randomize address signal addressed to ADDR1 (that is, if one or more additional responses to the address inquiry signal is received) the controller subsequently repeats the prior processing steps, namely the a) sending of the transmit address request signal to the devices in the neighborhood group, b) use of the first address received from the devices in response to the address request signal as the address ADDR1 of the first device in the neighborhood, c) transmission of the address inquiry signal to address ADDR1, d) receipt back of the response to the address inquiry signal from the first device, e) determination of whether one or more additional responses to the address inquiry signal are received from one or more of the other devices in the neighborhood, and f) sending of the randomize address signal addressed to ADDR1 if one or more additional responses to the address inquiry signal is received. It is noted that, following a randomize address signal, the first address received back from the devices in response to the address request signal will, of course, be different from the prior first address, since it has undergone a randomization. Thus, the address represented by ADDR1 will typically be different for each iteration through the processing.

When the controller receives back the response to the address inquiry signal from the first device and no additional responses to the address inquiry signal, the controller subsequently sends an identify request signal addressed to ADDR1 that instructs the first device to identify itself to an operator of the controller using a sensory output. Following receipt of the identification of the first device, the operator may input either a bind command or a skip command into the controller. The bind command causes the controller to bind the first device to a control group of devices controlled by the controller. The skip command causes the controller to leave the first device unbound.

### BRIEF DESCRIPTION OF THE DRAWINGS

The above and other objects, features and advantages of the present invention will become more apparent from the following detailed description when taken in conjunction with the accompanying drawings in which:

FIG. 1 is a representation of components of an IR lighting control system;

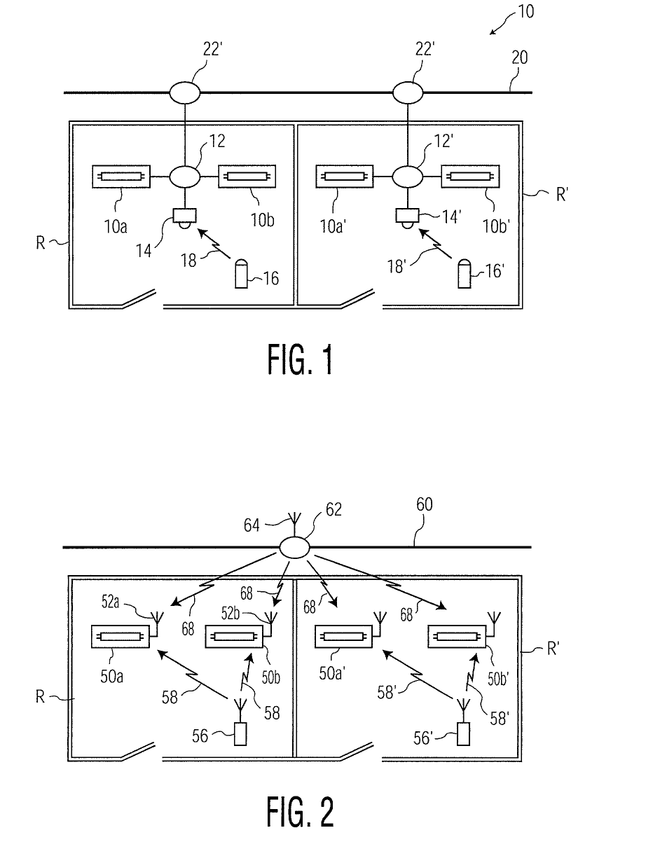

FIG. 2 is a representation of components of an RF lighting control system;

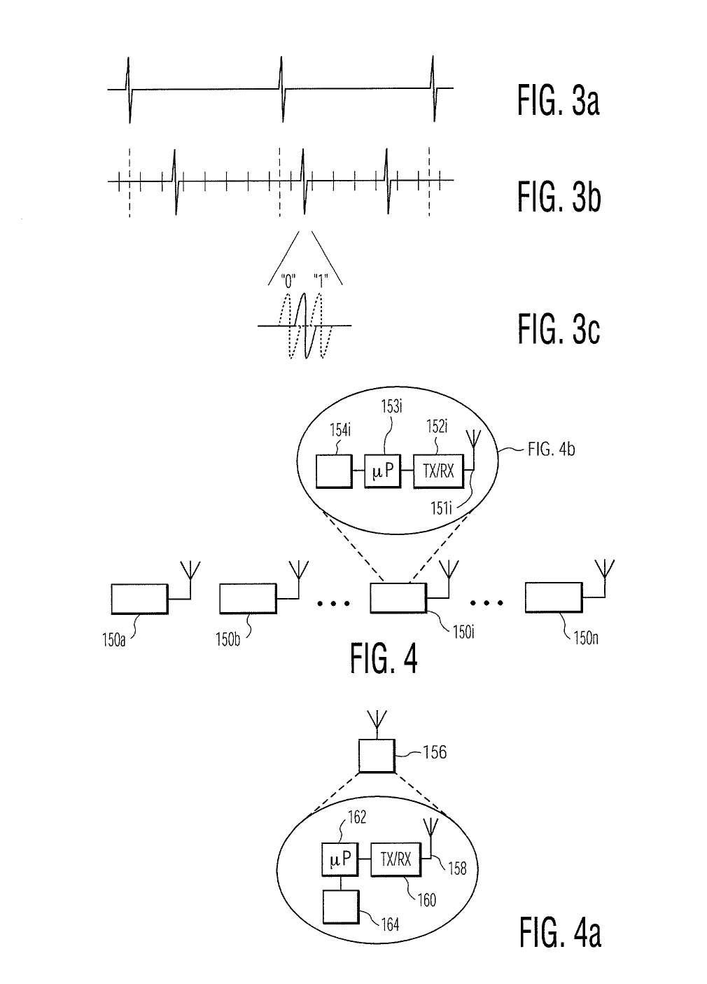

FIGS. 3a-3c are signals representative of Ultra Wide Band radio;

FIGS. 4-4b is a representation of components of an RF lighting control system that support an embodiment of the present invention; and

FIGS. 5-5B is a flow-chart of processing steps carried out in accordance with an embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail. It is noted that the ensuing description focuses on exemplary embodiments comprising a group of lamps. However, as reflected in the above Summary Of The Invention, the invention is generally applicable to a group of devices (which may be the same, similar, or different devices) that have appropriate signal processing capabilities to support the invention.

The systems and methods of the preferred embodiments of the invention utilize the recently-developed time modulated ultra-wideband (UWB) technology. UWB radio signaling uses extremely short pulses, for example, on the order of a few hundred picoseconds, which may be separated in time on the order of tens of nanoseconds (tens of thousands of picoseconds). Although UWB has been developed to increase bandwidth in wireless systems, the narrow pulse transmission may also be used to precisely synchronize the clocks of a transmitter and receiver and to measure the distance between a transmitter and a receiver to within a few centimeters by determining the time-of-flight of the UWB pulses. As described further below, these properties are used in a binding procedure to eliminate overlap.

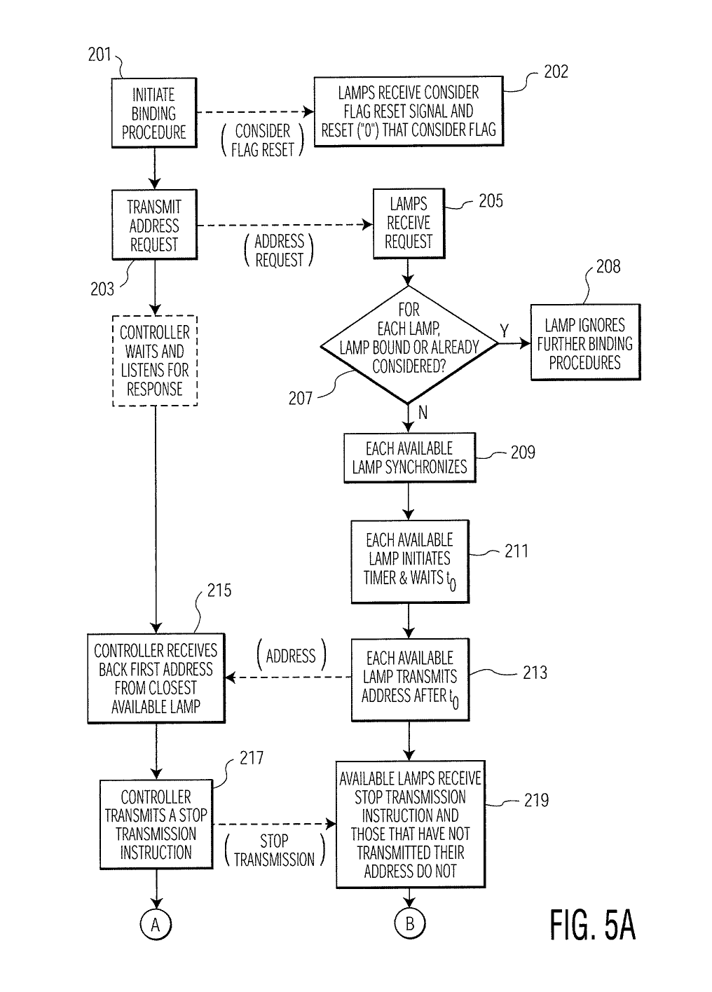

In UWB radio, a pulse sequence of monocycles is used as the RF communications channel. FIG. 3a provides a representative example of three monocycle pulses in an RF signal. The pulses shown in FIG. 3a are separated by a fixed interval. In general, the pulse train is coded with a repeating psuedo-random key, thus creating separate data channels that can be used to prevent interference between transmitters operating within the same area. FIG. 3b represents an encoded pulse train, where each pulse is moved to a random position within the separation interval, as determined by the key. In addition, each monocycle may be modulated to carry a bit of information (a “0” or “1”) by slightly varying the position of each pulse in time from its regular position in the sequence, as shown for one of the pulses in FIG. 3c.

Signal information is recovered from the pulse train using a correlation receiver. A correlator, programmed with the same code key for the particular data channel, takes the product of the received signal and the code key and integrates the result. The output data is then time-sampled to produce the demodulated data stream. As in any encoded system, a data stream is detected only when the code keys for the transmitter and receiver match. The correlator receiver uses this technique simultaneously on separate signals received that are displaced in time, thus recovering separate signals on the same channel.

Typically, the short term matching between the clock rates in transmitter and receiver may be synchronized to less than 100 ps rms. As noted above, the pulses typically have a pulsewidth on the order of a few hundred picoseconds over a pulse interval on the order of tens of nanoseconds. Thus, a synchronization signal (or any UWB signal that provides synchronization) emitted by the transmitter having these properties enables the receiver to synchronize its clock with the transmitter to the above-noted precision.

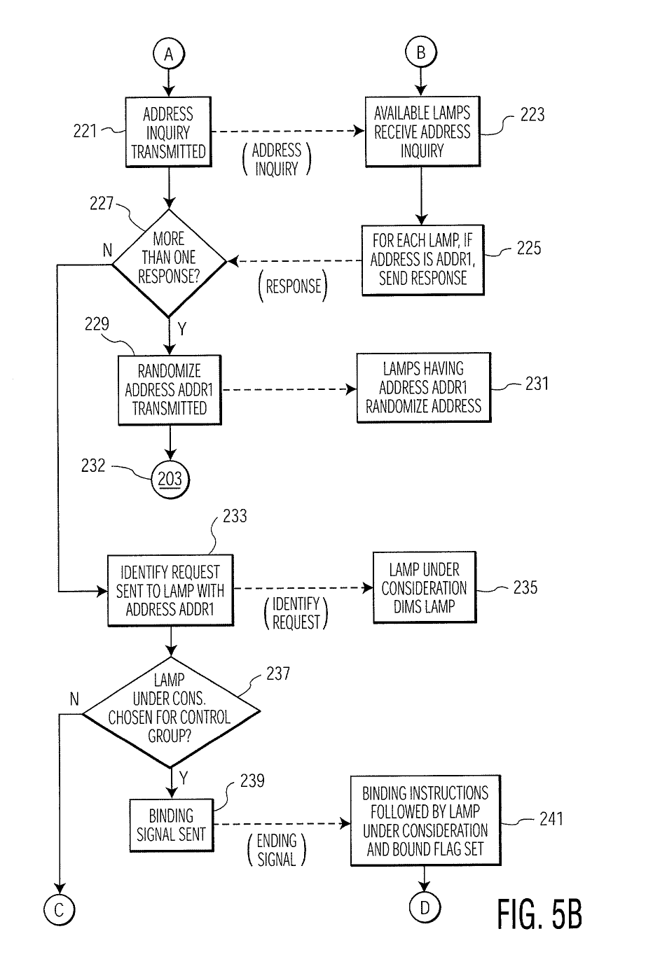

FIG. 4. depicts a system for wireless binding and control of lighting fixtures according to a preferred embodiment of the present invention. Shown in FIG. 4 is a controller 156 and a series of lamps 150a, 150b, . . . , 150i, . . . 150n (herein after collectively referred to with the reference number designation “150a-n ”) . Lamps 150a-n all comprise substantially the same components, including software, unless otherwise noted in the description below. Lamps 150a-n are either connected to or incorporated into the lighting fixtures (not shown). As described further below, some or all of lamps 150a-n are bound to controller 156 in a binding procedure and after such binding, the lamps that are so bound are controlled by controller 156.

Controller 156 is typically a wireless remote control for the lighting system, but may also be other devices, such as a network control box. As shown in FIG. 4a, controller 156 comprises an antenna 158 connected with transceiver 160. Transceiver 160 is connected with microprocessor 162 which is connected with user interface 164, such as a keypad. As described further below, microprocessor 162 is programmed to generate signals used to bind lamps (such as lamp 150i and any other of lamps 150a-n selected in the binding process) to the controller 156 and to control the lamps once bound. Signals generated by microprocessor 162 are transmitted to lamps via transceiver 160 and antenna 158; likewise, signals received via the antenna 158 and transceiver 160 are transmitted to microprocessor 162 for processing.

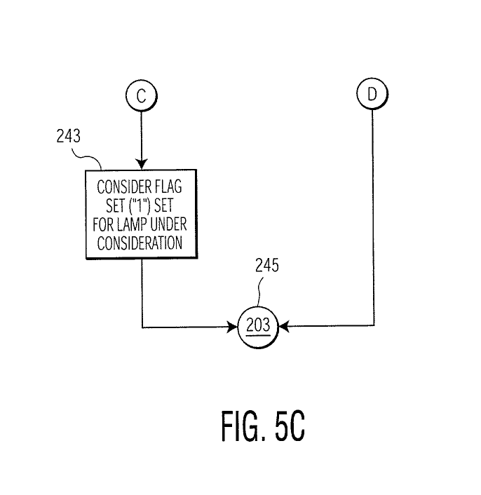

Turning next to the components of lamps 150a-n, for ease of description, components of representative lamp 150i are shown in FIG. 4b and described immediately below. It is thus understood that that the components and programming of lamp 150i are representative of any of the other lamps 150a-n in the description of FIG. 4b below. Lamp 150i comprises antenna 151i connected to a transceiver 152i which, in turn, is connected to microprocessor 153i. Microprocessor 153i is programmed to generate and receive signals used in the binding procedure between lamp 150i and controller 156 to bind lamp 153i to the controller 156 where selected (as described with respect to FIG. 5 below). Signals are received from controller 156 by microprocessor 153i via antenna 151i and transceiver 152i. Likewise, signals generated by microprocessor 153i are transmitted to controller 156 via transceiver 152i and antenna 151i. Microprocessor 153i is also programmed to receive control signals from controller 156 once bound and to generate corresponding control signals for the lamp 150i. Thus, microprocessor 153 is shown connected to lamp ballast 154, which is used to control lamp 150i.

Microprocessors 153i, 162 are programmed to generate and receive data signals of the UWB radio format described above, which are exchanged by controller 156 and lamp 150i in the binding procedure. If the UWB signals exchanged are modulated, then the transceivers 160, 152i of transmitter 156 and lamp 150i, respectively each include correlators. The correlators in the transceivers 152i, 160 each have the same code key in order to modulate (when transmitting) and demodulate (when receiving) the signal, as described above with respect to FIG. 3. The code key may be pre-programmed in each correlator or may be exchanged in a set-up procedure. In addition, after demodulation, received signals are time-sampled by the respective processors 153i, 160 to produce a demodulated data stream, as also described above. (For transmission of a signal, a data stream is formatted into binary data pulses analogous to those shown in FIG. 3c by microprocessors 153i, 162, and then modulated by the correlators in the respective transceivers 152i, 160 into a UWB signal analogous to that shown in FIG. 3b.) In addition, each microprocessor 153i, 162 includes a clock, where the clock rates may be synchronized to match better than 100 ps rms, as described above.

FIG. 5 is a flow chart detailing a binding procedure according to an embodiment of the present invention. As noted above, each lamp 150a-n has analogous components and programming as described for lamp 150i with respect to FIG. 4a above. In addition, although such analogous components of lamps 150a-n are not shown in figures analogous to FIG. 4a, the analogous internal components of lamps 150a-n will be referred to with analogous reference numbers where appropriate.

The processing procedure described with respect to FIG. 5 is programmed and performed by the microprocessor in the devices referred to, that is, either the microprocessor 162 of the controller 156 or one or more of the microprocessors 153a-n of the lamps 150a-n. As described above, the signals actually transmitted and received between controller 156 and lamps 150a-n may be modulated and demodulated by the correlators in the appropriate transceivers 160, 152a-n prior to and after transmission. Each lamp 150a-n is within the transmission range of a signal emitted from controller 156. Likewise, the controller 156 is within range of a signal emitted by each of lamps 150a-n. Thus, lamps 150a-n comprise a “neighborhood” group of lamps of controller 156 which may be considered for binding during the binding procedure.

Referring to FIG. 5, in step 201 the binding procedure is initiated, for example, by depressing an appropriate key on keypad 164 of controller 156. The initiation of the binding procedure results in a Consider Flag Reset signal being transmitted from the transmitter to the lamps 150a-n. In response to receipt of the Consider Flag Reset signal, each lamp 150a-n resets to 0 a Consider Flag. This flag signifies whether or not the lamp has been considered in the binding procedure.

Although not shown in FIG. 5, the initiation of the binding procedure of steps 201 and 202 may also include the transmitter sending a Bound Flag Reset signal to lamps 150a-n. Upon receipt, each lamp 150a-n may reset a Bound Flag to 0. As described below, this flag signifies whether or not the lamp is already bound, either to controller 156 or another controller. Thus, re-setting the Bound Flag in lamps 150a-n effectively erases any previous bindings of all the lamps 150a-n in the neighborhood of controller 156. Thus, transmission of the Bound Flag Reset requires a separate input by the operator via the keypad 164.

Controller 156 then transmits an Address Request to the neighborhood of lamps 150a-n. (step 203). The lamps receive the request in step 205. Because the lamps are located at differing distances from the controller 156, each lamp receives the Address Request at a different time, which increases with distance between the particular lamp and controller 156. After receipt, each lamp 150a-n determines if it is currently bound (either to controller 156 or another controller), as shown in step 207. Thus, each lamp 150a-n checks its Bound Flag (which is set in memory after a lamp has been bound). Each lamp 150a-n also determines if it has already been considered for binding by checking to see if its Consider Flag is 0 (meaning not yet considered) or 1 (meaning previously considered). If any of the lamps 150a-n have either been previously bound or previously considered, the procedure ends within each of those lamps (for example, the bound or previously considered lamps do not respond further to the binding procedure), as shown in step 202.

Each available (unbound and not previously considered) lamp of the neighborhood of lamps 150a-n that receives the Address Request synchronizes its internal clock to the Address Request signal, thus synchronizing its internal clock to within 100 ps rms of the clock of the controller 156, as described above (step 209). Each available lamp then initiates a timer that is driven by its internal clock, as shown in step 211. Each available lamp delays a pre-determined amount of time to before transmitting its respective address back to controller 156 (step 213).

Because the internal clock of each available lamp is synchronized to within 100 ps rms of the controller 156, each available lamp will impart a time delay of to having an error less than or equal to 100 ps. Where a lamp is located at a distance of a few meters, for example 3 meters, from the controller 156, the travel time between the controller and lamp is on the order of 3000 ps. Thus, the error in the time delay to due to synchronization effectively translates into an error of a few percent of the signal travel time.

For separation of a lamp and the controller 156 of a few meters (in the specific example, 3 meters), this effective error in travel time in turn translates into an effective error in the distance between the controller 156 and each available lamp of on the order of a few centimeters. Thus, where the distances between each of the available lamps and the controller 156 all differ by more than a few centimeters, the first address that the controller 156 receives back (in time) will be from the available lamp where the distance traveled by the Address Request signal and the returning address signal is a minimum. This, of course, is the available lamp closest to the controller 156. This is represented in step 215 of FIG. 5.

When the first address is received by the controller 156 (which, as noted, is from the closest available lamp), a Stop Transmission signal is emitted by the controller instructing the other lamps (who have not already transmitted their addresses) to stop transmission of their addresses (step 217). When received, the available lamps that have not already transmitted their addresses do not thereafter transmit an address (step 219).

After the first address (denoted ADDR1) is received, the controller 156 determines whether it is unique among the addresses of the available lamps. To do so, an Address Inquiry is transmitted by the controller 156 to the available lamps (step 221). The Address Inquiry includes ADDR1. Any lamp having address ADDR1 sends a response to the controller 156 (step 225). Controller 156 scans to determine if more than one lamp responds (step 227), waiting a sufficient amount of time to ensure that all responses are received. The closest lamp will, of course, respond. If more than one lamp responds, the controller sends a signal instructing all lamps having address ADDR1 to randomize their addresses (step 229). The lamps receive the signal in step 231 and those having address ADDR1 each select another address at random (step 231). As shown in step 232, the controller 156 returns to step 203 and repeats the binding procedure from the “transmit Address Request” step.

It is noted here that, if such a randomization occurs and the binding procedure returns to step 203, it will proceed in the same manner described above through step 227. However, since the first address ADDR1 received by the controller 156 from the nearest available lamp during the subsequent pass through the processing will have previously been randomized, it is highly unlikely that more than one lamp will now respond as having address ADDR1 in step 227.

If only one response is received in step 227 (namely, from the closest lamp, having address ADDR1), then the controller 156 sends an Identify Request (using ADDR1 to address the lamp) to instruct the lamp to dim its lamp so that the operator can see which lamp is under consideration (steps 233, 235). If the operator wishes to bind that lamp to the group of lamps controlled by controller 156 in step 237, then the operator pushes an appropriate key or keys on the keypad 164 of controller 156. A binding signal is formatted by the controller 156 and transmitted to the lamp under consideration (for example, by addressing the signal to the lamp with address ADDR1), as shown in FIG. 239. The signal includes the address of the controller 156 and a unique short address for the lamp under consideration (step 241). In response to receipt of the binding signal, the lamp under consideration re-programs its address to be a unique two-part address that is the combination of the controller address and the short address received. The controller 156 likewise programs this combined two-part address into its memory.

To prevent the possibility that the re-programmed two-part address of the lamp under consideration might overlap with the address of an unbound lamp in the neighborhood group, different address lengths are set for a bound lamp (such as the lamp under consideration) and an unbound lamp. For example, an unbound lamp may have a random address of 24 bits, whereas the bound lamp is set to respond to the controller address (having, for example, 24 bits) and a short address (having, for example, 8 bits), for a total address length of 32 bits. In addition, a lamp that has been previously bound to another controller will have a different controller address as part of its two-part address.

This completes the binding of the lamp under consideration to the controller 156. Thus, the lamp under consideration also sets its “bound” flag, as described above and also shown in step 241. After binding of the lamp under consideration, the procedure returns to step 203, so that the next nearest available lamp may be selected and considered by the operator for binding.

If the lamp under consideration is not chosen by the operator for binding to the controller 156, then the Consider Flag in that lamp is set to 1 in step 243 and the procedure returns to step 203, so that the next nearest available lamp may be selected and considered by the operator for binding.

Thus, the binding procedure of FIGS. 5-5b considers the closest available lamp for binding. The operator may either bind the lamp to the group controlled by the controller 156 or skip it. In either case, the lamp is either bound or has been considered and is thus no longer available. Thus, when the processing returns to step 203, the closest available lamp is the next nearest lamp to the controller 156. In this manner, each available lamp in the neighborhood of lamps is either bound to the group controlled by controller 156 or skipped in successive passes through the processing steps 203 to 245. At each iteration of the processing, if the closest available lamp under consideration has an address that is the same as another lamp included in neighborhood of lamps 150a-n, the addresses of the lamps having the common address are randomized, and the processing continues at step 203. Thus, the procedure eliminates unintentional binding of a lamp in the neighborhood because it has the same address as another lamp in the neighborhood.

In a preferred embodiment, each lamp in the group controlled by controller 156 is re-programmed in the manner described above with the same two-part address comprised of the controller address and short address. (Thus, in this case, the two-part address is “unique” in that it is unique to the group of lamps in the group controlled by the controller 156.) This facilitates the implementation of control commands subsequently transmitted by the controller, since only one two-part address need be transmitted by the controller 156 in order to address all of the bound lamps in the group.

The binding procedure of FIGS. 5-5b ends when there are no more available lamps in the neighborhood of lamps 150a-n at step 215. Thus, if the controller 156 does not receive an address in step 215, the binding procedure terminates. This may also result in an output (visual and/or audio) that unambiguously signals to the operator that the procedure is complete. (Such a clear signal from the system that the binding procedure has ended prevents the scenerio, for example, where a lamp under consideration dims its light in step 235 of FIG. 5a, but is in another room and not visible to the operator. In that case, the operator may incorrectly assume that the binding procedure has ended before it actually has.) Alternatively, the operator may manually terminate the processing earlier (for example, when those particular lamps slated to be part of a bound group are all bound) by depressing an appropriate key on the controller's keypad 164.

As described above, after the binding procedure is completed, each lamp that is bound to the group controlled by controller 156 has the same unique two-part address, which is comprised of the controller address and a unique short address. The controller 156 also has stored in memory the unique two-part address, which may now be used to uniquely address the lamps bound in the group controlled by controller 156. Thus, when a control key is pressed on the keypad 164, controller 156 emits a corresponding control command signal that includes the two-part address that addresses all of the bound lamps in the group. A lamp is programmed to respond to the control command signal only if it is addressed in the command signal. The command control signal sent may incorporate the instruction “on”, “off”, “dim 10%”, etc. Thus, when the command control signal is transmitted, all of the bound lamps will be addressed simultaneously and will thus respond to the command.

As previously noted, it is preferred that each lamp to be bound to the group controlled by controller 156 is re-programmed with the same two-part address during the binding procedure. This allows each lamp to be simultaneously controlled with a single control signal emitted by controller 156 that addresses the two-part address. While different two-part addresses may be re-programmed into each lamp to be controlled by controller 156 during the binding process (comprising, for example, the controller address and a different short address for each lamp), this is a more complex implementation. In such an implementation, when a control key is pressed on the keypad 164, the controller 156 must emit a corresponding control command signal that addresses each of the different two-part addresses of each lamp bound to the controller 156.

In a further refinement of the above-described binding embodiment pertaining to FIGS. 5-5b, the binding procedure may require the controller 156 (and thus the operator wielding the controller) to be within a certain specified distance from a lamp for it to be considered for binding. The binding procedure is substantially the same as that given in FIGS. 5-5b with some modification. For example, in step 15, the controller 215 may be set to scan for the addresses received within a maximum delay interval measured from the transmit request (in step 203). The requirement that the signal be received within a maximum delay interval effectively designates a maximum radius between the controller and a lamp must lie in order for the lamp's address to be received in step 215.

The correlation between maximum delay interval and maximum radius between the controller and a lamp is given by:

d=(Δt−t₀)(c/2) (Eq. 1)

where: d is the maximum radius between the controller and a lamp,

Δt is the maximum delay interval measured by the transmitter,

t₀ is the time delay imparted by all lamps before transmitting their address, as previously described, and

c is the speed of light.

By selecting an appropriate maximum delay interval, for example, the operator can be required to be within a distance of 5 feet (or less) of those lamps that are considered for binding. If the controller 215 does not receive an address within the maximum delay interval in step 215, the controller waits a predetermined amount of time and then returns to step 205 and submits another transmit request. This gives the operator time to move around the room(s) to be near each lamp as he carries out the binding procedure, without having to re-start the binding procedure. (Such re-initiating of the binding procedure would lead to an undesired re-setting of the Consider Flag in step 202). This may be a more natural protocol for the technician that carries out the binding procedure.

Although the controller 156 has been depicted and described above as a hand-held device, it is readily seen that it may be incorporated into other devices, including a fixed controller, such as a network computer and control box. In addition, the processing described above may be divided between a network control box and a remote. Thus, the remote may allow the operator to signal the controller included in a network control box to initiate the binding procedure. When the controller in the network control box requires an operator input, for example, choosing or skipping a select lamp as in step 237 of FIG. 5A, signals may again be exchanged with the remote whereby the operator provides the desired selection. In addition, the processing of the binding procedure need not physically occur in the network control box, but may occur at a remote computer. The network control box may include a transceiver that is used to exchange signals with the neighboring lamps; the signals may be processed (for example, according to the steps of FIGS. 5-5b in a remote computer that communicates with the control box via a bus. Subsequent control signals may be initiated by the network computer and directed to the appropriate network control box or boxes for transmission to the bound lamps.

In addition, where the controller 156 is a hand-held remote as in the abovedescribed embodiments, after the binding procedure is complete, the addresses of the bound lamps in the controlled group may be downloaded to a network computer and control may be implemented by the network computer via the appropriate network control box.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A system comprising a wireless controller that binds one or more devices from a neighborhood group of devices to the controller, the controller having a processor that processes data and formats signals and a transceiver that transmits and receives signals, the controller in a binding procedure transmitting an address inquiry signal to an address (ADDR1) of a first device in the neighborhood, receiving back a response to the address inquiry signal from the first device, determining whether one or more additional responses to the address inquiry signal are received from one or more of the other devices in the neighborhood group, and sending a randomize address signal addressed to ADDR1 if one or more additional responses to the address inquiry signal is received.

2. The system as in claim 1, wherein prior to the controller transmitting an address inquiry signal to address ADDR1 of the first device in the neighborhood, the controller in the binding process sends a transmit address request signal to the devices in the neighborhood group and uses a first address received from the devices in response to the address request signal as address ADDR1 of the first device in the neighborhood.

3. The system as in claim 2, wherein where the controller sends a randomize address signal addressed to ADDR1 if one or more additional responses to the address inquiry signal is received, the controller subsequently repeats the a) sending of the transmit address request signal to the devices in the neighborhood group, b) use of the first address received from the devices in response to the address request signal as address ADDR1 of the first device in the neighborhood, c) transmission of the address inquiry signal to address (ADDR1) of the first device in the neighborhood, d) receipt back of the response to the address inquiry signal from the first device, e) determination of whether one or more additional responses to the address inquiry signal are received from one or more of the other devices in the neighborhood, and f) sending of the randomize address signal addressed to ADDR1 if one or more additional responses to the address inquiry signal is received.

4. The system as in claim 3, wherein where the controller receives back the response to the address inquiry signal from the first device and no additional responses to the address inquiry signal, the controller in the binding process subsequently sends an identify request signal addressed to ADDR1 that instructs the first device to provide a sensory output that identifies itself to an operator of the controller.

5. The system as in claim 4, wherein following receipt of the output identification of the first device, the operator inputs one of a bind command and a skip command, the bind command causing the controller to bind the first device to a control group of devices controlled by the controller and the skip command causing the controller to leave the first device unbound.

6. The system as in claim 5, wherein the binding of the first device to the control group in response to the bind command comprises storing a unique address for the first device in memory.

7. The system as in claim 6, wherein the binding of the first device to the control group in response to the bind command further comprises the controller transmitting a signal addressed to the first device at ADDR1 instructing the first device to re-program its address from ADDR1 to the unique address.

8. The system as in claim 7, wherein the devices are lamps.

9. A device that may be bound to a wireless controller, the device comprising a processor having an address and a transceiver over which signals are transmitted and received, the processor in a binding procedure programmed to a) transmit a signal comprising the address in response to receipt of an address inquiry signal, b) randomize its address in response to receipt of a randomize address signal, c) transmit a responding signal in response to receipt of an address inquiry signal addressed to the address.

10. The device as in claim 9, wherein the processor in the binding procedure is further programmed to re-program the address upon receipt of a signal addressed to the address and comprising a new address.

11. The device as in claim 10, wherein the device is a lamp.

12. A method of binding one or more devices from a neighborhood group into a control group that are controlled together, each device having an address, the method comprising the steps of
a) requesting the addresses of the devices in the neighborhood group;
b) considering a first address received from the devices in response to the address request as an address (ADDR1) of a first device in the neighborhood group;
c) querying the devices in the neighborhood group whether they have address ADDR1 of the first device in the neighborhood;
d) receiving a response to the query of step c from the first device;
e) determining whether one or more additional responses to the query of step c are received from one or more of the other devices in the neighborhood group; and
f) instructing all devices having address ADDR1 to randomize their addresses when one or more additional responses to the query of step c is determined to be received in step e.

13. The method as in claim 12, wherein steps a to f are repeated until it is determined in step e that no additional responses to the query of step c are received.

14. The method as in claim 13, wherein, after it is determined in step e that no additional responses to the query of step c are received, the method further comprises the step of: g) instructing the first device to provide a sensory output that identifies the first device to an operator.

15. The method as in claim 14, further comprising the steps of:
h) binding the first device as part of the control group;
i) removing the first device from further consideration in the binding procedure; and
j) repeating the method beginning with step a.

16. The method as in claim 14, further comprising the steps of:
h) removing the first device from further consideration in the binding procedure without binding the first device as part of the control group; and
i) repeating the method beginning with step a.

17. The method as in claim 12, wherein the devices are lamps.
